(19) United States
(12) Patent Application Publication
(10) Pub. No.: US 2015/0379860 A1
(43) Pub. Date: Dec. 31, 2015

(54) SYSTEM AND METHODS OF TRACKING USING RADIO FREQUENCY IDENTIFICATION

(71) Applicant: TECHIP INTERNATIONAL LIMITED, Lamaca (CY)

(72) Inventor: Eyal Dov VARDI, Bet Nir (IL)

(21) Appl. No.: 14/546,717

(22) Filed: Nov. 18, 2014

Related U.S. Application Data
(60) Provisional application No. 62/018,485, filed on Jun. 27, 2014.

(51) Int. Cl. G08B 25/10

(52) U.S. Cl. CPC G08B 25/10

(57) ABSTRACT

A system for tracking movement of assets or persons includes a presence sensor coupled to an RFID exciter or transmitter. Upon detection of object presence by a sensor, the exciter is turned on and caused to transmit an RFID tag exciting signal. The signal may be received by and activate a corresponding RFID tag that is within range of the exciter. The RFID tag may then transmit its ID, the ID of the exciter, and the sensed presence information to a remote RF receiver and back-end data processing system.

### CROSS-REFERENCE TO RELATED APPLICATIONS

This application claims priority to U.S. Provisional Application No. 62/018,485, filed Jun. 27, 2014, the contents of which are hereby incorporated by reference in its entirety.

### FIELD

The technology herein generally relates to movement or location tracking (e.g., in real-time) of assets or people by using radio frequency identification devices.

### BACKGROUND AND SUMMARY

Radio frequency identification (RFID) relates to tracking, identifying, or otherwise interrogating electronic “tags” using radio frequency (RF) electromagnetic fields to power on-board electrical circuits and/or to provide one or more RF communication channels. Generally speaking, an electronic RFID tag (e.g., a “RFID tag” or “tag”) includes an electronic circuit to process and store information and an RF antenna or transceiver to send and/or receive information via electromagnetic signals of at least one frequency.

RFID tags may be further broken down into various sub-categories that include passive tags, active tags, and passive tags that include a battery, and the like. Passive tags may be powered via onboard capacitors that are charged when sufficient electromagnetic radiation is received. Active tags typically use an onboard battery to power the included transceiver and other circuits. Passive tags with a battery may use received electromagnetic radiation to bootstrap into an active mode that then relies upon an onboard battery to power on-board circuits. There are many different types of RFID tags as those in the art will appreciate.

One technique of tracking an RFID tag uses signal strength recorded by multiple readers located at different locations. The strength of the respective signals can be used to triangulate the RFID tag location. However, such triangulation techniques may not be preferred in indoor environments due to the presence of walls, partitions, or other barriers that physically separate portions of a facility without necessarily separating the RF signals emitted from receivers, tags, and/or multi-path signal artifacts (e.g., caused by at least partial absorption or reflections of such RF signals). For example, RFID readers may be placed on opposing sides of a wall. But due to the physical proximity of the readers it may be difficult to determine on which side of the wall an RFID tag is located. Further, movement of doors, persons, or the like within a room may affect the signal strength readings.

Another technique for identifying the position of an RFID tag in a facility is to place readers within different known “zones” of the facility. For example, a reader can be placed at a choke point (e.g., a reception desk) or in a specific room within the facility. Readers can be narrowly tailored to only pickup/activate RFID tags within a certain area (e.g., a given room). This technique, however, may have downsides as well.

For example, zones may have a minimum 2-3 meter radius of active area per zone indicator (e.g., the effective range of an exciter or other RFID reader). However, in certain environments (e.g., healthcare facilities), the rooms may be designed to have only 1-2 meters between door frames to different rooms. Given the typically complex layout of these and other facilities (e.g., multiple entrances per corridor, multiple elevator banks, etc.), the installation and setup process per zone indicator can be complex and time consuming. Moreover, there is still a chance that a tag close to a wall in room ‘A’ will be incorrectly “detected” as being in the zone of Room ‘B’.

Also, in certain environments, zone indicators can overlap and result in an inaccurate or lost RFID tag location. For example, overlapping low-frequency RF signals may destructively combine to at least partially “destroy” each other—thus rendering tags that enter these “dead-zone” areas with an unknown or wrong location.

Still further, in traditional implementations, zone indicators are continually in an “on” state emitting an RF signal. While electromagnetic emissions from a single low-frequency RF transmitter (or other exciter/receiver/transmitter) may be well under a possibly harmful range, a facility with tens or hundreds of continually emitting zone indicators may have a cumulative effect. The consequences of such cumulative exposure may be unknown.

Another potential issue is that the volume of data messaging between tags, zone indicators, and a central system can exponentially increase when additional zone indicators are introduced into the typical prior art system (e.g., to increase accuracy, cover additional rooms, etc.). The increase in data transmissions and related data processing can lead to a need for additional computing power so that the increased traffic may be timely handled. For example, each zone indicator may cause all in-range tags to transmit multiple messages that in turn need to be stored and processed (e.g., algorithmically analyzed to estimate the location of a tag, to discard duplicate or not relevant data, etc.).

Conventionally, when an RFID tag location is determined there is no trajectory-associated information related to the interrogated tag. Instead, systems may need to infer such information. For example, a system may provide a point location for a tag at a given time, with multiple reads per single location (e.g., depending on a zone radius). However, until the tag enters a new zone (i.e., progresses from a first zone to a second zone) no concrete directional information may be provided. Smoothing algorithms can be used in an attempt to create a rough graphical and or statistical representation—e.g., a “walk path” or movement playback for the RFID tag location. However, the processing involved can be computationally expensive (and still prone to error due to the nature of considerable “guesswork” involved)—and even then only providing an indication for large increments of tag movement.

Thus, it will be appreciated that new, improved, and/or otherwise interesting techniques in this area are continually sought after.

Certain example embodiments relate to presence selective exciting and reading where RF Readers, zone indicators, LF exciters, and the like may be activated based on an object's movement and onsite presence.

In certain examples, one or more traditional zone indicators may be augmented with sonic, passive infrared, laser active, or similar range finder devices to more immediately generate presence, trajectory, and/or speed data for a target object. A local presence indication of an object may selectively trigger activation (e.g., turn “on”) of one (or more) nearby normally “off” zone indicators of a facility that may then communicate with and/or excite an in-range RFID tag. This selective activation may also result in data being transmitted to a remote computing resource (e.g., a server) for further processing (e.g., data that is based on communication with an RFID tag).

By augmenting traditional zone indicators with such selective local “turn-on” several advantages may be achieved.

For a first example of such advantages, zone indicators may now have a decreased minimum separation radius. In other words, zone indicators may be placed closer to each other (e.g., on the opposing sides of wall) because the problem of overlapping signals providing plural conflicting tag locations is less of a problem (e.g. due to RF transmissions only coming from a “turned-on” device on one side of the wall being responsive to detected local movement on that same side of the wall). In certain instances, there may be no minimum radius of clearance per zone indicator. For example, adjacent zone indicators may be activated with directional selectivity. In certain examples, the required separation can be as narrow as a laser beam.

Second, zone indicators may even use overlapping areas of coverage due to the indicators not always being “on.” Thus, for example, additional low frequency RFID receivers/exciters can be placed in overlapping zones. This can lead to increased accuracy and/or decreased processing resources needed for determining the location and/or movement path of a particular asset (and its associated RFID tag) within a facility.

Third, zone indicators may be placed into a nominally “off” or sleep mode with little or no EMF emissions—unless triggered to a temporary “on” state. The selective activation of a given zone indicator leads to 1) a total reduction in EMF exposure risk for those within a given facility; 2) a total reduction in data traffic (e.g., over wired or wireless connections) because of decreased quantity of data being transmitted (e.g., from a zone indicator, its controller, and/or the RFID tag); and/or 3) reduced load on backend servers that perform data processing associated with the data traffic.

Fourth, in certain examples, the tag location information provided by the augmented presence indicators may itself also provide trajectory and speed information (e.g., via a laser range finder). This additional information can be used to decrease processing resources (e.g., at backend servers) needed for determining where a particular tagged asset is headed. For example, the need to “guess” or “smooth” obtained trajectory information can be eliminated or decreased. Additional presence and/or trajectory information can be used to provide real-time actual information and/or to provide an instant replay capability.

In certain examples, improved accuracy can be achieved for tag location information by the addition of new data sets per tag that include trajectory and speed of the asset (or tag associated with the asset).

Certain example embodiments may also provide increased security. For example, when a sensor of a zone indicator is activated and no corresponding tag data is received (e.g., in response to being excited) the system may assume that the detected object is without a tag. An alert (e.g., a page, e-mail, text, alarm, etc.) can then be issued or logged based on the detection of such occurrences. This can lead to increased safety and/or security for a facility.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is an example of a technique of using zone indicators;

FIG. 2 shows an example zone indicator according to certain example embodiments;

FIG. 3 shows another example of a deployed zone indicator according to certain example embodiments;

FIG. 4A is a diagram of a facility with multiple deployed zone indicators;

FIG. 4B is another view of the diagram of FIG. 4B with transmissions from the zoned indicators shown;

FIGS. 4C-1-4C-4 are diagrams of a facility with zone indicators according to certain example embodiments;

FIG. 4D is a timing diagram showing when respective zone indicator units are turned on and off;

FIG. 5 shows different types of sensors that may be used in conjunction with an example zone indicator;

FIG. 6 is a flow chart of a process according to certain example embodiments;

FIG. 6A is a flow chart of a process according to certain example embodiments;

FIG. 6B is a flow chart of processes performed across a ZIU, an RFID tag, and a receiver/server according to certain example embodiments;

FIG. 6C is a flow chart of processes performed across a ZIU, an RFID tag, a receiver, and a central controller according to certain example embodiments;

FIG. 7A is a flow chart of an example process performed by an RFID tag;

FIG. 7B is a flow chart of an example process performed by a zone indicator device;

FIG. 7C is a flow chart of an example data processing operation performed in connection with a detected RFID tag;

FIGS. 8A and 8B show an example of a zone indicator unit;

FIG. 9 is a block diagram of an example computing resource according to certain example embodiments;

FIG. 10 shows another example of a zone indicator unit; and

FIGS. 11A-11C show diagrams of example deployed zone indicator units according to certain example embodiments.

### DETAILED DESCRIPTION

The following description is provided in relation to several example embodiments that may share common characteristics and/or features. It is to be understood that one or more features of any of the embodiments may be combinable with one or more features of other example embodiments. In addition, any single feature or combination of features in any of the embodiments may constitute an additional embodiment. As used herein, the term “or” is meant to be inclusive (e.g., either A or B individually, or both A and B together) rather than exclusive (e.g., A or B, but not both).

Certain example embodiments herein may relate to systems and methods of tracking (e.g., in real-time) the position of an asset using radio frequency identification (RFID). In certain example embodiments, RTLS (real time location services) and RFID (radio frequency identification) are used to determine the location of a RFID tag. When the tag is in an area with an active electromagnetic radio frequency transmitter (e.g., low frequency transmission such as, for example, a 125 KHz carrier frequency), those RF (radio frequency) transmissions may “excite” the tag (e.g., a passive RFID tag) that includes a receiver tuned to the transmitted frequency. The excited tag may then transmit its own identifier and the identifier of the zone indicator (which was included in the exciting transmission) wirelessly (e.g., via UHF, Wi-Fi, Bluetooth®, ZigBee, or other technique) to a suitably nearby RF receiver. Additional information such as speed and trajectory information may also be transmitted to the tag (e.g., from a physical presence detector that causes the RF transmitter to excite and/or communicate with an RFID tag) and then from the tag to the nearby RF signal receiver. It will be appreciated that the receivers and/or transmitters mentioned herein may be receiver and transmitter circuits within transceivers.

An RF data receiver that receives such transmissions can in turn propagate this information (e.g., via a wired or wireless connection) to a backend computer system for processing and/or further use. The location data in the transmission from the tag can also be used by the receiver or a corresponding controller to independently activate other controllers or zone indicators based on local rules (e.g., that are processed by the receiver). For example, information may be passed onto a nearby electronic door lock to controllably open (or lock) a door, to turn on a light, or control some other electrical equipment. This localized and distributed process may be used to decrease the amount of data being sent to a central processing resource (e.g., a server computer system).

Accordingly, a tag location can be known at the moment it is at (or within) range of the zone Indicator and thus additional actions can be taken based on this information. In certain examples, the range of a zone indicator may be determined by the power or strength of the RF emitted from the transmitter and may be a 3D sphere around the transmitter at a radius that may be from a few centimeters to tens of meters.

In certain example embodiments, a zone indicator device has transmitter (e.g., emitting at a relatively low RF frequency such as 125 Khz) that is normally in an off state (e.g., by default) so that it is not continuously emitting an RF signal and, in at least some embodiments, also not even continuously pulsing a low duty cycle RF signal unless an object (e.g., that is moving) is earlier detected by a corresponding zone sensor module. In other words, the zone indicator is selectively controlled to turn to its “on” state (e.g., emitting RF either continuously or intermittently at regular short intervals) based on detection of movement of an object within a vicinity of the zone indicator-rather than continuously providing such RF transmissions. In certain examples, a zone indicator may be activated by the “presence” of an object within its detection range.

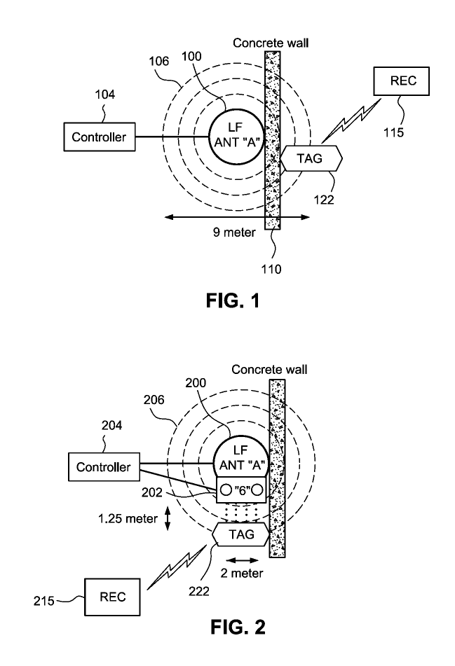

FIG. 1 depicts an example of using an always “on” zone indicator. Zone indicator 100 is deployed within a room of a facility and has an ID of “A” assigned to it. For example, controller 104 may assign an identifier to each zone indicator that it controls. Zone indicator 100 also includes an exciter/transmitter (e.g., and a corresponding antenna) used to excite or communicate with a receiver (e.g., an RFID tag) that is within the range of the zone indicator 100.

Area 106 covered by the exciter/transmitter of zone indicator 100 is about 9 meters in diameter and omni-directional (e.g., a ball shape in space that covers a 3D volume with the antenna in the center). In this example, zone indicator 100 is placed near concrete wall 110. However, due to RF signal propagation the sphere-like 360 degree coverage area for the exciter/transmitter extends through concrete wall 110. The exciter/transmitter in FIG. 1 is continually in an “on” state or may be pre-set to continuously pulse the RF signal for 20 milliseconds every 200 milliseconds—or some other continuous or semi-continuous scheme as those in the art will appreciate. Other types of pre-set routines (e.g., on for a certain variable amount of time and then off for another variable length of time in a continuous manner) are also possible.

Accordingly, a system (e.g., the controller 104 or the zone indicator 100) may communicate with or excite RFID tag 122 when the tag enters the range 106 of zone indicator 100. Specifically, when tag 122 enters the range of zone indicator 100 it may be excited and activated to trigger another RF communication channel transmission from tag 122 to receiver 115 (e.g., using a higher RF frequency). The tag to receiver communication data may include an identifier of tag 122 and an identifier of the zone indicator (e.g., “A”) that activated the tag (e.g., which was communicated via the initial exciting RF transmission). This transmitted information may be used (e. g., by a backend server connected to receiver 115) to determine tag 122 is in zone “A”, which is associated with zone indicator 100.

One potential issue with this type of deployment is that the RFID tag 122 might be located anywhere within 3D space 106. Thus, while an RTLS system may know tag 122 is within this relatively small area (e.g., 9 meters), it may still be undetermined on which side of concrete wall 110 the tag 122 is located.

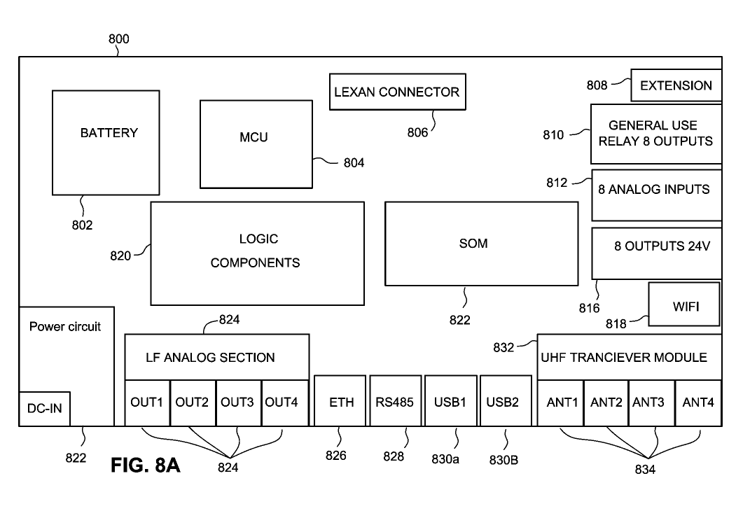

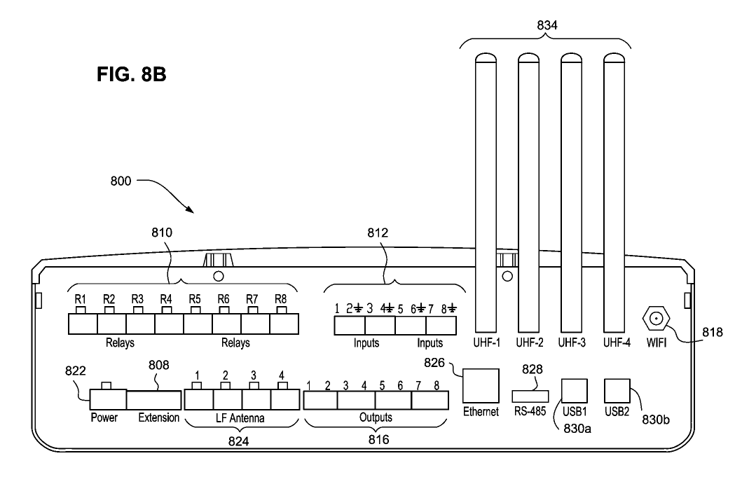

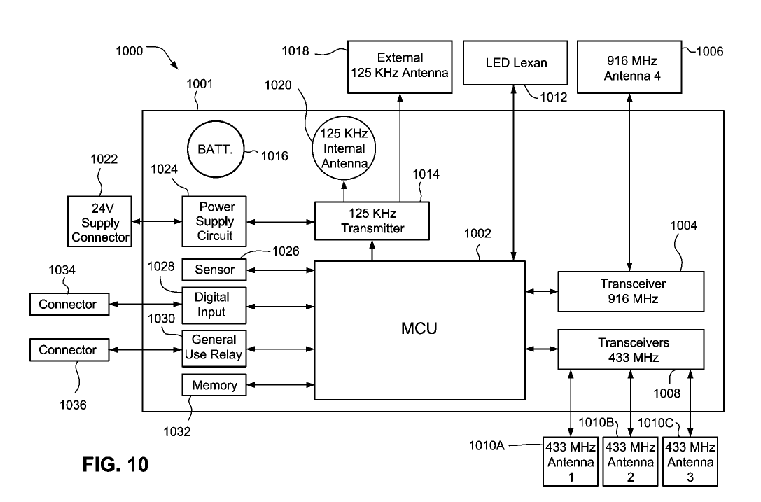

FIG. 2 shows an example zone indicator 200 according to certain example embodiments. Example zone indicator units (ZIUs, the functions containing both a zone indicator and an object presence sensor to activate the zone indicator are also sometimes referred to more simply as zone indicators) are described herein—e.g., FIGS. 8A and 8B, and FIG. 10. Here, in FIG. 2, zone indicator 200 has been augmented with presence sensor 202 (e.g., an ultra-sonic object presence and range finder sensor). Sensor 202 may be used to detect the presence, distance, movement, and/or direction of an object located with respect to the sensor (e.g., by reflection of an array of sonic wave signals). Both sensor 202 and/or associated zone indicator 200 may communicate with a controller 204. Such communications may be via a wired connection (e.g., Ethernet or the like) or may be wireless (e.g., 802.11x)

Example sensors used in conjunction with a zone indicator/exciter may be set to “monitor” a particular portion of 3D space. For example, a sensor 202 may be programmed to sense objects between 0 and 2 meters with a 30 degree angle vertically and a 15 degree angle horizontally (e.g., with respect to a central detection axis) from the location of the sensor. Sensors added to a zone indicator may thus be configured for the geometry in which the zone indicator is located. For example, sensor 202 may detect tag 222 within about 1 or 2 meters and about 180 degrees from the zone indicator 200. Sensor 202 and zone indicator 200 may each be assigned a specific identifier. For example, zone indicator 200 may have an identifier of “A” (or a particular room number) and sensor 202 may have an identifier of “6.” As explained below, the identifiers may be communicated to a RFID tag within communication range of the zone indicator if it is activated to an “on” state.

Zone indicator 200 may have its transmitter (e.g., an LF transmitter between about 30 kHz and 300 kHz) normally set to an “off” state with little or no RF emissions until sensor 202 senses the presence of an object. Once an object enters the range of sensor 202, the sensor may send a signal (e.g., an electrical signal) to the controller indicating an object has been detected. In response to the presence signal from sensor 202, controller 204 activates zone indicator 200 (e.g., its transmitter) for a particular period of time so that the detected object within the sensor range may now be excited (in the case of a passive RFID) by the transmitted RF signal. During the period when the zone indicator 200 is “on,” the transmitter thereof may transmit an RF signal coverage area 206. It will be appreciated that coverage area (e.g., an area of space that is within communication range of the transmitter) may be of a suitable size depending on the needs of particular environment (e.g., from 5 m to 60 m or greater). Any “tag” within the transmission range may then be activated based on this transmission. In certain examples, a directional antenna may be used to focus the coverage area of the transmitter (e.g., so that the coverage area is a shape other than circular or spherical).

Of course, the sensor 202 could also locally activate the zone indicator 200 to its “on” state. The transmission from the zone indicator 200 to the tag 222 may include the ID of the zone indicator, the ID of the sensor (e.g., “6”), and/or other pre-determined positional information.

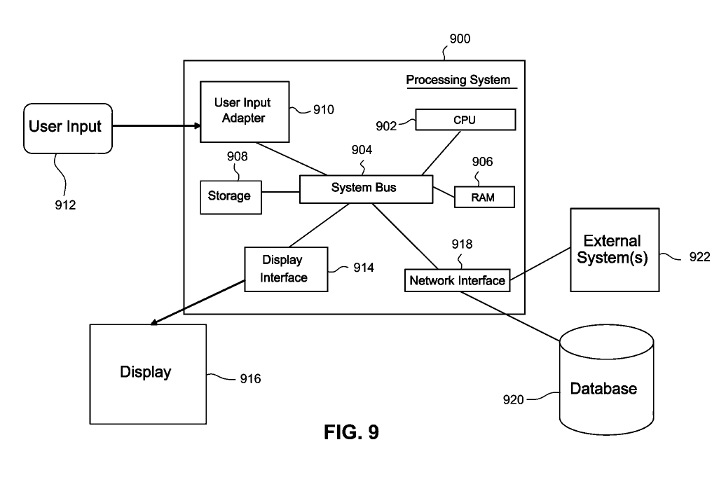

The excitation of tag 222 may cause the tag to perform a wireless RF transmission to receiver 215 (which may, in turn, be connected to a backend server where received data is processed). This transmission may include the ID of tag 222 (e.g., a unique identifier “x”, the name of the person the tag is associated with, etc.), the ID of exciting zone indicator 200 (e.g., “A”), and the ID of the sensor that detected the object (e.g., “6”). A computing system (e.g., as shown in FIG. 9) coupled to the receiver 215 may automatically record the received information—e.g., that tag X has entered zone “A,” and sub-zone “6.” After exciting tag 222, the transmitter of zone indicator 200 may be actively switched back to its “off” state or it may automatically become again quiescent after a predetermined amount of time such as 10, milliseconds, 50 milliseconds, 1 second, etc.

As indicated above, information concerning activation of a particular zone indicator may be combined with information identifying a “sub-zone” associated with sensor 202. In FIG. 2, the sub-zone is “6” and the zone is “A.” Accordingly, the controller (or central computing system or other computing resources) may record both the zone and sub-zone that tag 222 is located within. This information may be transmitted (e.g., during the initial exciting signal) to the in-range RFID tag and for subsequent retransmission to receiver 215 and further computing resources.

In addition to zone and sub-zone information, information on the speed and/or trajectory of the detected object may be determined (e.g., due to the use of a sonic range finder). This additional information may be transmitted to the tag 222 from the zone indicator 200 and then retransmitted to receiver 215 to be stored in association with the zone information.

It will be appreciated that example zone indicators may be associated with multiple different types of sensors that cover different (or overlapping) areas within a defined space associated with a zone indicator. Thus, zone indicators may have multiple sub zones (which can be associated with different sensor types) to increase location accuracy and information concerning the detected object that enters the zone covered by a zone indicator. For example, a zone indicator may have a narrow laser-based sensor that covers the entry way to a room and a sonic sensor that covers the remainder of the room. The laser sensor may thus provide an accurate indicator of someone entering or leaving the room and the sonic indicator may provide information on movement in the room.

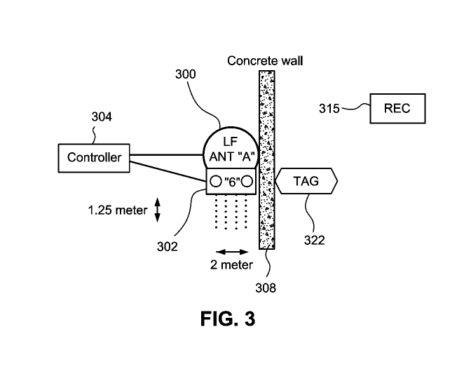

FIG. 3 shows another example of a deployed zone indicator according to certain example embodiments. Here, zone indicator 300 includes a range finder sensor 302 (and thus constitutes a zone indicator “unit” in certain example embodiments). Both zone indicator 300 and sensor 302 are coupled to controller 304. Like the example shown in FIG. 1, zone indicator 300 can transmit at a certain RF frequency over a volume of space. Also like in FIG. 1, tag 322 is within range for the transmitter of zone indicator 300 and on the opposite side of concrete wall 308. However, unlike the example shown in FIG. 1, zone indicator 300 remains in an “off” state and the location of tag 322 is thus unknown (at least from the perspective of zone indicator 300). This is because whether zone indicator 300 (e.g., the LF transmitter of the zone indicator) is “on” or “off” is determined by a presence detection of an object. Here, the object associated with tag 322 is on the opposite side of the wall from zone indicator 300 and accordingly its associated sensor 302 does not detect the presence of an object. Therefore, the LF transmitter of zone indicator 300 remains “off” and no communication occurs between zone indicator 300 and tag 322 or between tag 322 and receiver 315 (e.g., because tag 322 is not excited or activated by zone indicator 300).

In certain examples, in an “off” state the zone indicator (e.g., the transmitter) generates no RF. In certain examples, “off” includes generating RF, but at an insufficient power level to excite a passive RFID. In other examples, “off” includes a standby mode of the transmitter. In contrast, a zone indicator in an “on” state is continually or continuously transmitting (at least at some rational duty cycle so as to insure what is effectively an “on” state) so that in-range RFIDs are promptly activated (e.g., to power passive RFIDs or to activate RFIDs). In certain example embodiments, zone indicators may be set by default to an “off” state so there is little or no emission from corresponding zone indicator 300 RF antennas until the presence or movement of an object is detected by an associated server 302.

A zone indicator unit (ZIU) designed to communicate with and track RFID tags may itself include: 1) one or more controller devices 304; 2) at least one RF transmitter (e.g., a low frequency RF transmitter); 3) at least one object sensor (which may include an ultra-sonic range finder, infra-red range finder, passive infrared detector, barometric pressure detector, laser line sensor, radar, and the like); 4) a power source (e.g., battery or centrally provided power via facility AC circuits or the like); and 5) wireless or wired communication directly or indirectly (e.g., via receiver 315) circuitry to communicate with a central computing system.

In certain example embodiments, a controller may have multiple LF RF transmitters (e.g., RFID exciters) each assigned to a different spatially selective “zone” by the controller (e.g., the transmitters and supporting circuitry may constitute a ZIU). Each ZIU exciter is coupled or associated with at least one sensor. The controller receives information from the sensor(s) and provides instructions to the exciters (e.g., to turn “on”). The instructions may include data (e.g., speed, trajectory, zone information, etc.) that is to be included in the transmission. Such data may originate from the sensor or other sources (e.g., the controller or RFID tag, etc.).

While the examples provided herein may be applied in an indoors environment (e.g., a hospital, health care facility, office, or the like), the techniques may also be used in an outdoor setting, or a combination thereof (e.g., on an oil rig). For example, a sporting event, an amusement park, or other facility (whether indoors or outdoors) may employ the techniques and systems described herein.

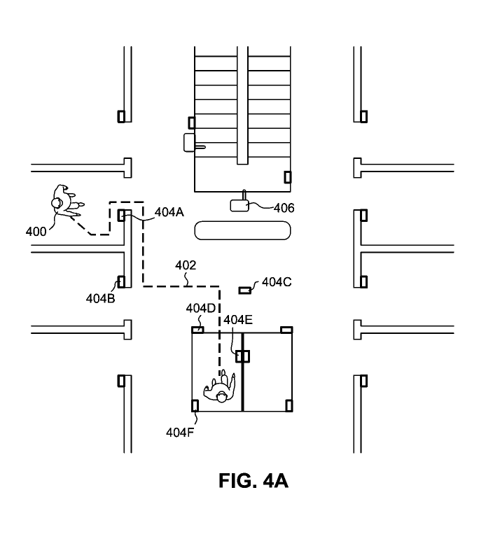

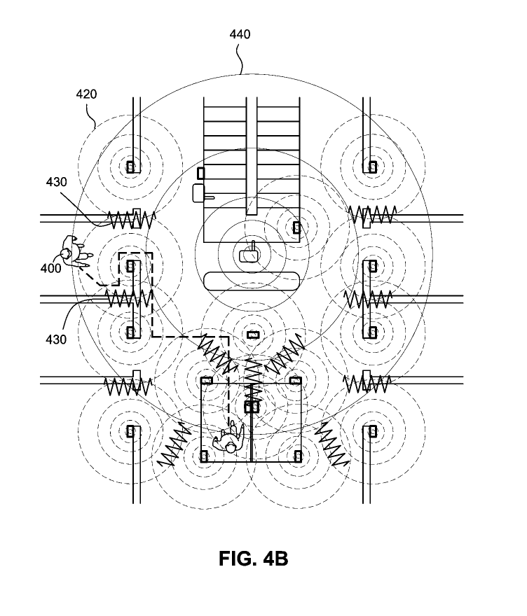

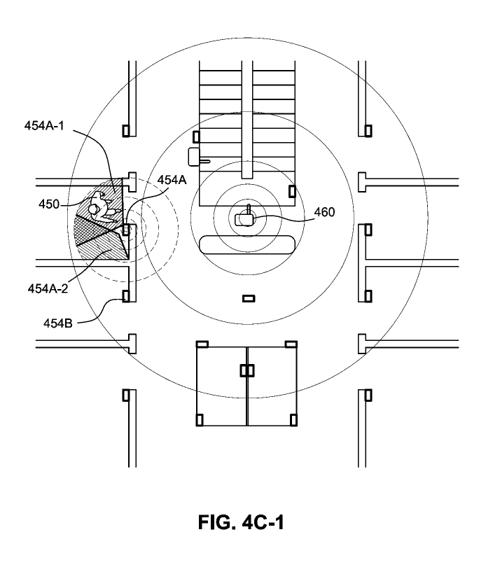

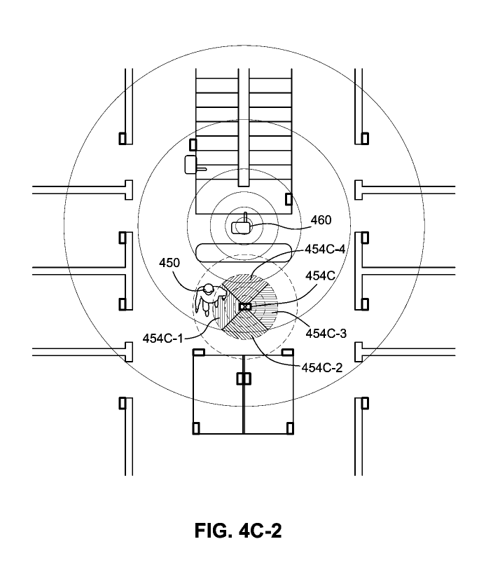

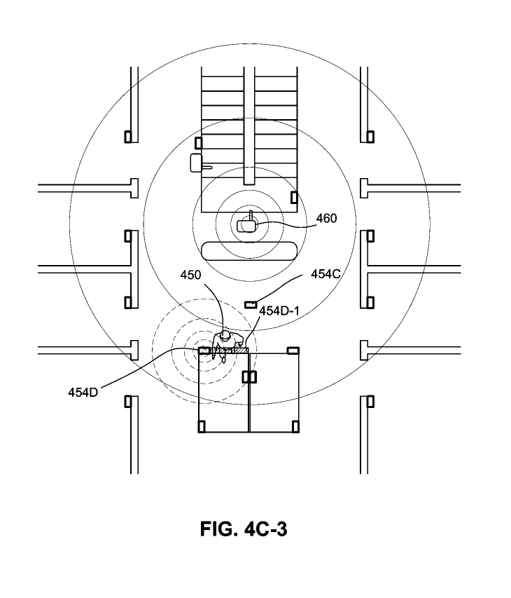

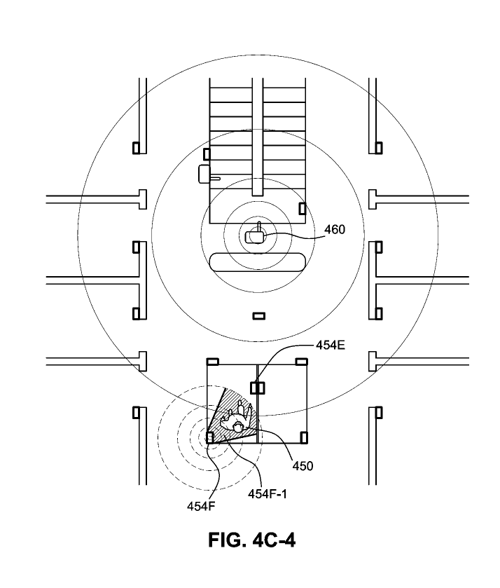

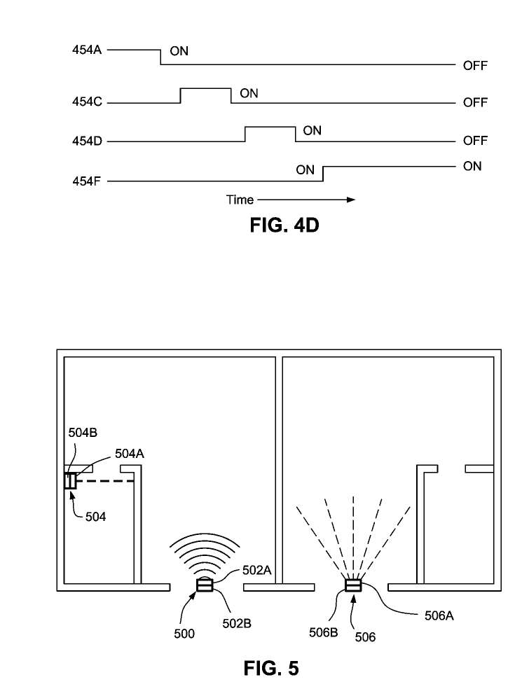

FIG. 4A is a diagram of a facility with multiple deployed zone indicators and FIG. 4B is another view of the diagram of FIG. 4B with RF transmissions from the zoned indicators shown by dashed-line concentric circles.

The facility in FIGS. 4A and 4B includes multiple zone indicators 404A, 404B, 404C, 404D, 404E, and 404F. Zone indicators as depicted in FIG. 4B are assumed to continually (or periodically) transmit RF signals (e.g., always in an “on” state to promptly excite an RFID tag located within range of a given zone indicator) as depicted by dashed concentric circles 420. Responsive to activation, an RFID tag receives a transmitted zone identifier (from the activating zone indicator) and then transmits its own tag identifier and the received zone identifier (of the zone indicator) to receiver 406. Receiver 406 generally has a larger communication range and may be designed to communicate via Wi-Fi standards (802.11x), cellular standards, or the like. The increased range of receiver 406 is indicated by solid lines 440 forming longer concentric circles in FIG. 4B.

In FIGS. 4A and 4B person 400 follows a path 402 from a room to an elevator. As person 400 moves through the facility, the RFID tag carried by the person will become excited by different zone indicators, which may then cause a corresponding transmission to receiver 406 (or another remote system receiver).

In certain areas of the facility, the signals from two or more zone indicators may overlap (e.g., at 430) and cause interference. When person 400 passes through these areas of interference, the RFID tag being carried may not receive an appropriate exciting signal (e.g., because two out of phase competing RF signals might cancel each other) and thus an overall movement tracking system (back at a central processor) may lose track of person 400 for a short (or extended) period of time.

Due to these and other issues, installing zone devices can be problematic and require a large investment of time and money as even the best pre-planning cannot account for every variable in how generated RF fields will interact. This uncertainty can later (e.g., after a system has been deployed) require onsite troubleshooting. This follow-up process can involve reinstallation of zone indicators (e.g., tearing out existing wire, opening walls) in an attempt to address an RF signal interference problem.

FIGS. 4C-1-4C-4 are diagrams of a facility with zone indicator units (ZIUs) according to certain example embodiments. These figures show person 450 proceeding along the same path shown in FIG. 4A. In this example, the placement of zone indicators is also assumed to be the same as in FIGS. 4A & 4B. However, the zone indicators in FIGS. 4C-1-4C-4 are augmented by (or already include) additional sensors (e.g., sensors that sense the presence, location, position, and/or movement of an object) as discussed herein. Accordingly, exciting RF transmissions from zone indicators may be selectively emitted based on whether or not movement or presence (e.g., of person 450) is detected in an area (or sub-area) covered by the corresponding zone indicator.

Referring to FIG. 4C-1, person 450 is in a room with ZIU 454A. ZIU 454A includes a pair of spatially selective sensors that monitor respectively associated shaded areas 454A-1 and 454A-2 for the presence and/or movement of an object. In this case person 450 is within area 454A-1 and is thus detected by the corresponding sensor of ZIU 454A. In response to this detection, a controller of the ZIU may activate zone indicator 454A (but not any other zone indicator) and cause a LF RF tag exciting transmission. This initial LF RF transmission may activate an RFID tag on person 450 (e.g., which is within range of the zone indicator 454A), which may then communicate with receiver 460 over another RF communication channel. As the person 450 leaves the room, the sensor(s) associated with zone indicator 454A will no longer detect object presence and/or movement and the LF RF transmissions from zone indicator 454A will no longer be triggered—e.g., zone indicator will be turned “off” (either actively or automatically by time-out).

The amount of time or duty cycle the transmitter of the ZIU is turned “on” may vary by application and the particular deployment scenario associated with the particular ZIU. In certain examples, the LF transmitter of a ZIU may be turned on for 5 seconds and then switched off. In another example, the LF transmitter may be turned on for 100 milliseconds and turned off. In another example, the transmitter may remain “on” until an active “turn-off” response command is received from the RFID tag (e.g., relayed thereto by a remote computer system or programmed into the RFID tag logic).

Upon leaving the room, person 450 passes by zone indicator 454B. However, no LF RF tag activated transmissions will be triggered because the movement sensor for zone indicator 454B is oriented towards the room (or doorway) that is associated with indicator 454B and thus the movement or presence of person 450 is not detected by zone indicator unit 454B.

As person 450 continues moving towards the elevator, zone indicators may be selectively “activated” (and then deactivated) based on corresponding sensors detecting movement of the person 450. As indicated in FIGS. 4C-1-4C-4, there will be less total RF emission from the zone indicators (e.g., because only 454A, 454C, 454D, and 454F are each successively activated—other ZIU units may also be activated as person 450 is detected by those respective units) during the time it takes person 450 to reach the elevator.

Referring to FIG. 4C-2, ZIU 454C includes 4 object sensors that respectively monitor quadrants 454C-1, 454C-2, 454C-3, and 454C-4 around the area of ZIU 454C. Once person 450 enters areas 454C-1, the transmitter of ZIU 454C is activated and causes the RFID tag carried by person 450 to wake up and report its position to receiver 460.

Referring to FIG. 4C-3, ZIU 454D includes a sensor that covers a relatively narrow area of space 454D-1 in front of and parallel to the elevator doors. In certain examples, the sensor used by ZIU 454D is a laser. In certain examples, the sensor and/or the corresponding ZIU are integrated into the door of the elevator and may cover only the door opening space. In any event, once person 450 crosses into area 454C-1, the transmitter of ZIU 454D is activated and the RFID tag carried by person 450 communicates with receiver 460.

In FIG. 4C-4, person 450 enters the elevator and moves towards the back of the elevator car. This movement may cause ZIU 454E to activate (e.g., based on the area covered by a corresponding object sensor). Once at the back of the car, the sensor of ZIU 454F that covers area 454F-1 detects the presence of person 450. This triggers a transmission from the RFID tag carried by person 450 to receiver 460.

It will be appreciated that the sensors associated with a ZIU (e.g., a particular transmitter) also may be remotely positioned and communicate with a common transmitter through a common controller (e.g., a microcomputer or other computer system). For example, the elevator may include two presence sensors located at different locations within the elevator. One sensor may be at the location of ZIU 454E (e.g., in the elevator ceiling) and another at the location of ZIU 454F. Detection of object presence by either of these sensors may trigger a transmission from a common transmitter that covers the elevator car but the spatially selective area associated with the triggering sensor may be identical in the data transmitted by the RFID circuits.

FIG. 4D is an illustrative timing diagram showing activation and deactivation of the respective ZIU's discussed above (e.g., when a transmitter is turned “on” and then subsequently “off”) corresponding to FIGS. 4C-1-4C-4.

FIG. 5 depicts different types of sensors that may be used in conjunction with an example zone indicator unit. Zone indicator 500 may include a sensor 502B and an exciter 502A (e.g., a transmitter with a corresponding antenna). Sensor 502B is a passive infrared (PIR) sensor that may detect the presence of an object in the room. A PIR sensor may also detect motion by measuring changes in the infrared (heat) levels emitted by surrounding objects. When motion is detected the PIR sensor outputs a high signal on an output pin. This signal may be recognized and then acted upon (e.g., to activate an exciter transmitter). PIR sensors can be obtained from, for example, Parallax Inc.

In certain examples, a PIR sensor may have two states. Specifically, once the PIR detects movement it will cause the LF RF exciter to be turned “on” and when no movement is detected (or after a certain period of time—e.g., 1 second) the LF exciter may be automatically turned “off”. In this type of example, no additional processing for the object sensor data may be needed.

Zone indicator 504 includes an exciter 504B and a laser sensor 504A (aimed across a small room entrance doorway) that will sense when someone enters the small room.

Zone indicator 506 includes an exciter 506B and a sonic sensor 506A used to determine speed and/or trajectory of an object within the room. One illustrative example of a sonic sensor is an “Ultrasonic Ranging Module HC-SR04” that is available from Elec Freaks. It will be appreciated that other types of movement or presence sensors may be used according to certain example embodiments. For example, an infrared proximity sensor may be used. An illustrative example of this type of sensor may be the Sharp GP2Y0A02YK0F.

Other types of sensors may also be implemented. For example, a sensor configured to sense sound may be used to detect noises. In response to such noise or sound detections, a transmitter may be turned on. In certain instances, a filter or other technique may be used to isolate certain types of sounds that are used to trigger a ZIU.

In another example, camera is used in conjunction with object recognition techniques. For example a CCTV camera may be used to acquire images of a hallway in a facility. Object recognition techniques may be performed by identifying staff members from patients. For example, all staff members may have a particular bag or logo that is worn on their uniform.

In another example, a temperature sensor is used to detect a change in temperature and in response to this detection a given ZIU is activated. In another example a trajectory sensor can be used to obtain trajectory information of a moving object.

A controller may be coupled to one or more these sensors and perform additional processing on the received signals to determine trajectory and/or speed of a detected object. This additional data (e.g., the trajectory and speed), as explained herein, may be linked to the identifier of an RFID tag for further processing (e.g., where is the tag location going, what additional processing should be triggered based on its current location and expected destination, etc. . . . ).

An object sensor coupled to the zone indicator also can always be active or “on” or may be selectively turned on/off according to an operating schedule that may be set or determined by the controller or another computing resource (e.g., a central scheduling system). In certain examples, sensors are turned on/off by presence detection of other sensors. For example, a sensor at an elevator may detect movement and send a signal to other sensors on a floor to activate.

In certain example embodiments, the sensor may itself include a data and signal processing engine (e.g., a processing circuit) to support detection capabilities of the sensor. In certain examples, this processing functionality may be offloaded onto a coupled external controller and/or another remote computing resource.

In certain examples, existing zone indicator systems (e.g., as shown in FIG. 4B) may be retro-fitted with sensor capabilities as described herein. For example, a sonic sensor may be connected to control an existing zone indicator. Alternatively, or in addition, zone indicators may be manufactured with such sensors integrated therein (e.g., a ZIU). Controllers of exciters may be associated with multiple sensors that are each responsible for one or more areas that are served by that exciter.

In certain example embodiments, an electrical circuit may bridge the exciter and the sensor such when the sensor detects the presence of an object the circuit is flipped to an “on” state for a predetermined period of time that triggers the exciter to transmit an exciting RF transmission for an RFID tag. The use of such circuits may control the exciters/transmitters much the same way a light switch controls a light bulb in a room.

In certain example embodiments, sensor information may be passed to a more complex processing arrangement that determines the speed and/or trajectory of a sensed object (e.g., by comparing sensed information from one time period to sensed information from another time period). For example, a presence sensor may have multiple individual indicators (e.g., optical receptors) successively triggered (e.g., to sense the object) as an object moves in front of the sensor. These successive indications may be used to infer a direction of movement for the object. The directional information, as discussed herein, may be included in future transmissions to an RFID and/or remote computing resources. In certain examples, the directional determination may be used to preemptively activate other zone indicators.

In other words, the techniques for activating an RF transmitter based on sensed information may be adjusted in accordance with the needs of a particular application and the desired complexity level (e.g., a simple electrical circuit versus additional processing logic that is controlled by a centralized computing system).

Naturally, the above noted processing capabilities may be provided through the sensor, the transmitter, a remote computing resource, or another third-party processing resource that receives sensor information and controls the zone indicator (e.g., the transmitter).

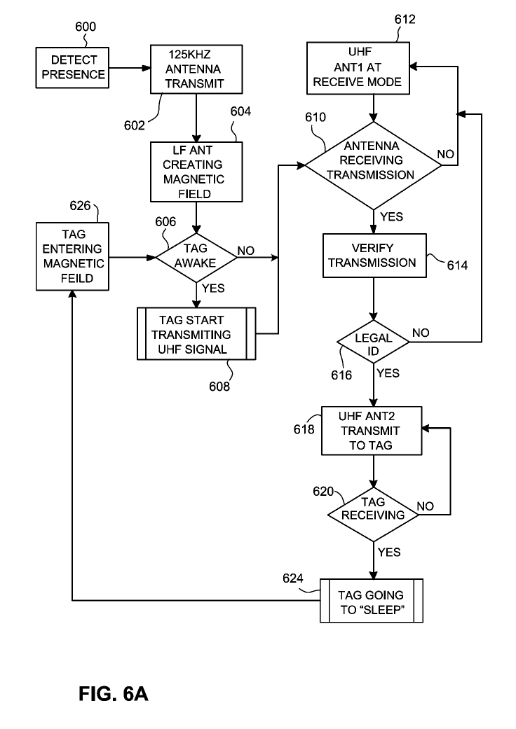

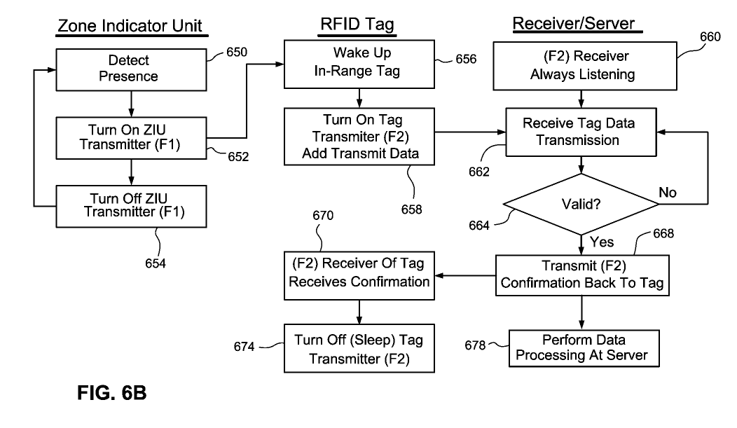

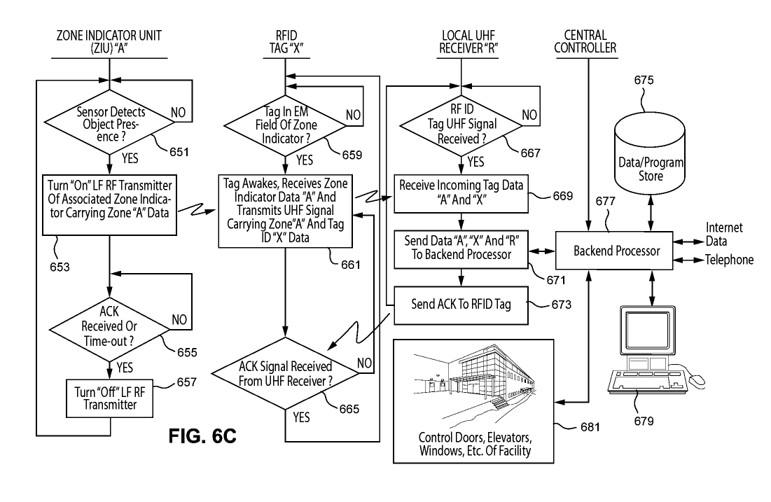

FIG. 6A is a flow chart of a process according to certain example embodiments. In step 600, a sensor detects movement or presence of an object within its sensor range. This information is passed onto a controller that issues a command to turn on a corresponding low frequency transmitter in step 602 (in this example a 125 kHz transmitter is used). In certain examples, the sensor may directly turn the LF transmitter “on” at step 602 (e.g., without the intervening controller).

As a result of turning on the transmitter in step 602, an electro-magnetic RF field is created in step 604. As described herein, this LF transmission may include data to identify the particular zone indicator that is associated with the transmission. If an RFID tag is within range, then in step 606, the tag is excited or woken up and caused to transmit a responsive UHF RF signal in step 608 to a UHF receiver.

If the tag is not within range, then no responsive signal is transmitted and the process may be considered to proceed to steps 610 and 612 because no transmission will have been received by the UHF receiver. Alternatively, a UHF signal may have been transmitted from the tag in step 608, but just not received by the receiver in step 610. In either case, if no transmission is received, the process moves to step 612 where the UHF receiver continues to wait for incoming transmissions. As described herein and in certain examples, if presence has been detected and no corresponding transmission is received, an alert may be triggered (e.g., for a possible intruder, unauthorized person or object, etc. . . . ).

In step 612, a receiver (e.g., a UHF RF receiver) has been placed into receive mode (or is continually in receive mode) to receive a UHF RF signal. The process loops between steps 610 and 612 waiting for incoming transmissions.

Once the signal from the tag is received in step 610, then in step 614 a data processing circuit verifies the basic nature of the data transmission (e.g., that the transmission is complete, has not been corrupted, is properly formatted, etc.).

In step 616, once the general nature of the transmission is verified, the ID of the tag in the transmission from 608 is then verified to ensure the tag ID is valid or legal. In certain examples, this is accomplished by performing an algorithmic check on the ID number (e.g., by hashing the ID, much the same way a credit card number is checked). In certain examples, the ID is checked against a database of currently active IDs to verify the authenticity of the received identifier.

If the tag ID is not verified or the general transmission is not verified, then the process discards the transmission and returns to step 612 to wait for further transmissions. It will be appreciated that in certain examples, the process may “exit” upon determining that the general transmission is malformed or not relevant without proceeding to the tag ID verification step.

In step 618, if the tag ID is verified, then a UHF transmitter transmits an acknowledgement back to the tag.

In step 620, the RFID tag receives the transmission that was sent in step 618 and goes to sleep in step 624. If no transmission is received, the tag waits until the acknowledgement transmission is received before going to sleep. In certain examples, the tag may also include a timeout period that is started upon transmission of the UHF signal from the tag to the receiver. Once the timer runs out (e.g., and no acknowledge has been received), the tag may go to sleep.

The tag re-enters a sleep state in step 624 until the tag re-enters an active electro-magnetic exciting RF field again in step 626.

FIG. 6B is a flow chart of example processes performed across a ZIU, an RFID tag, and a receiver/server according to certain example embodiments. A ZIU includes at least one sensor used to detect the presence of a nearby object.

In step 650, the presence of an object is detected and causes (e.g., electrically, electronically, automatically, programmatically, and/or the like) the ZIU to turn on one or more transmitters to transmit at frequency F1 in step 652. The transmitted F1 may include a coded signal that indicates the ID of the ZIU (e.g., “A”). As discussed above additional information such as sub-zone or trajectory information may also be included. In certain example embodiments, the F1 frequency is a 125 kHz frequency that is used to generate a LF field around the ZIU to excite any in-rage RFID tags. It will be appreciated, that the frequencies described herein may be any frequencies. For example, the frequencies of the various transmissions from the respective components may all be performed over the same frequency (e.g., all low frequency, all high frequency, or another frequency range).

After beginning the transmission in step 652, the transmitter of the ZIU will typically remain “on” for a predetermined amount of time (e.g., 50 milliseconds, 5 seconds, etc. . . . ) and/or wait for an acknowledgement transmission from the RFID tag (e.g., indicating that the RFID tag has been activated). In either of the above cases, the transmitter F1 is switched “off” in step 654.

Transmission F1 performed by the ZIU in step 652 may cause in-range RFID tags to wake-up or activate (e.g., a passive RFID tag or an active RFID tag) in step 656.

Once activated, the RFID tag will turn on an onboard transmitter F2 (e.g., UHF 433 MHz transmitter). The RFID tag may also format a message to be transmitted via the transmitter F2. This message may include the ID of the ZIU received over the F1 frequency, the ID of the RFID tag (e.g., stored in local memory on the RFID tag), and other information based on application need (e.g., the sub-zone information and trajectory information mentioned above). In step 658, the transmitter on the RFID tag may transmit the message over frequency F2. In certain examples, the RFID tag sends the data message one time. In certain examples, the RFID tag continually sends the data message until the receiver acknowledges receipt. In certain examples, the RFID continues to transmit the data message for a period of time before automatically shutting down.

In step 660, a remotely located receiver is listening on frequency F2. In certain example embodiments the receiver is located with the ZIU (e.g., in the same enclosure—see FIG. 10). In such an embodiment, the detection of presence in step 650 may also trigger the activation of the receiver F2. In other words, the transmitter and receiver of a ZIU may both be selectively triggered by a presence detection.

In certain example embodiments, this receiver is located at a position that is different from the ZIU (e.g., receiver 460 in FIG. 4C-1). In this example, the receiver is maintained in an “on” position and configured to receive transmissions over a wide area (e.g., 20 meters or greater).

In any event, in step 662 the receiver receives the data transmission sent from the RFID tag. In step 664, the receiver (e.g., a computer processor coupled to the receiver) performs one or more validation processes on the received data transmission.

The validation processes may include validating that the transmission is complete, has not been corrupted, etc. In certain examples when the ZIU includes both the LF transmitter and the UHF receiver, the ZIU may also determine if the transmission from the RFID tag includes a ZIU ID that matches the ZIU ID that includes the receiver. This allows ZIU's to filter out messages sent by RFID tags that were not caused by that same ZIU.

In certain examples where the ZIU hosts both the LF transmitter and UHF receiver, the ZIU can perform location and other processing for its “own” RFID tags. In certain examples, this includes filtering out an RFID tag that is stationary and within communication range of the ZIU. This local filtering option can further reduce the amount of network traffic and centralized computing processing that is needed as the “quality” of the data being reported to a central processing resource (e.g., a server) is increased.

Another example validation process includes determining if the RFID ID is a valid identifier. This may include performing a look-up against a database that holds a list of active RFID tags, performing a hash on the tag ID (or other algorithmic check), and other types of processes to confirm the ID of the RFID tag is valid.

If one or more of the validation processes fails, then the process returns and continues to wait for further transmissions from the RFID tag. For example, if the data message from the RFID was corrupted in the first transmission, the RFID tag may (as discussed above) be programmed to continually transmit the data message until the receiver sends an acknowledgement (or for a period of time). In such a situation, the receiver will receive the data message on a further transmission and perform the validation process again.

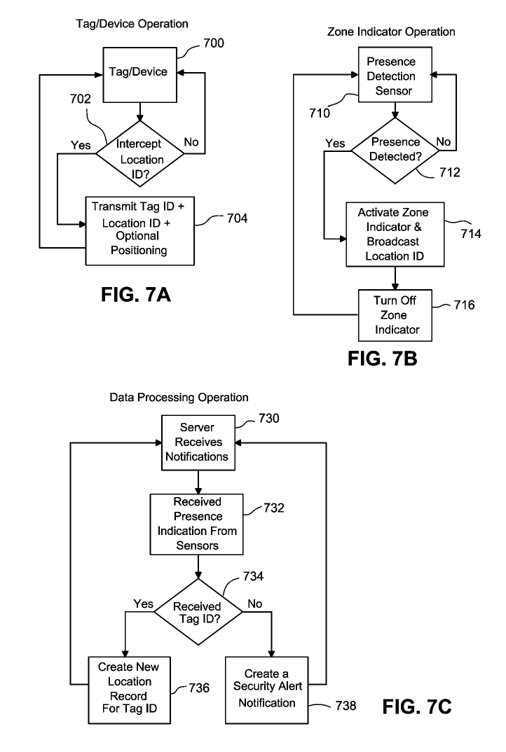

In certain examples, if one or more validation processes fail, an alert or notification may be triggered by a backend computer process. This is described in more detail in connection with FIG. 7C.

If the validation processes are successful, then in step 668 a transmitter is turned on and transmits a confirmation or acknowledgement back to the RFID tag at frequency F2.

In step 670, the RFID tag receives the transmitted confirmation message over frequency F2 and then turns off (e.g., goes to sleep) in step 674. In certain examples, the RFID tag may also transmit an acknowledgement message back to the receiver.

After transmitting the confirmation message in step 668, the data received by the receiver is sent along to a computing server for processing, analysis, and/or storage in step 678. In certain examples, the receiver may wait to receive an acknowledgement message from the RFID tag before sending the data (or may send the data and also wait for acknowledgement).

In certain example embodiments, additional data processing may be added. For example, a non-verified tag IDs may indicate a security breach. In other words, the RFID tag that was detected and activated was a currently invalid (or not recognized) tag. Naturally, this could also be a false positive (e.g., from another RFID tag carried by a person). The verification of the ID of the RFID tag may filter out those RFID devices not related to the facility or area in question.

In certain examples, additional processing may occur if a presence (e.g., movement) is detected, but no RF transmissions are received from a corresponding tag. Again this could indicate a security problem (e.g., an intruder without an authenticated RFID tag).

FIG. 6C is a flow chart of processes performed across a ZIU, an RFID tag, a receiver, and a central controller according to certain example embodiments. Some of the elements and operations described in FIG. 6C are similar to those included in FIG. 6B.

At step 651, ZIU “A” checks (e.g., a presence sensor of the ZIU) if presence of an object has been detected. If no presence is detected, the ZIU continues to loop over step 651. If presence is detected, the process moves to step 653.

In step 653, the ZIU turns on an associated LF RF transmitter and sends transmissions via the activated LF transmitter. The transmission includes zone “A” data—e.g., data that indicates the ID of ZIU “A” and other data as needed.

In step 655, the ZIU waits for a timer to expire. Alternatively, or in addition, the ZIU waits for and acknowledgement transmission from an RFID tag. While no acknowledgement has been received or the timer has not expired, the ZIU loops over step 655. Once the timer expires and/or an acknowledgement is received, the ZIU proceeds to step 657 and the associated LF RF transmitter is switched back “off.”

In step 659, if the RFID tag “X” is in the field of a zone indicator (e.g., ZIU “A”), the process moves to step 661. If the no activating zone is present, then the RFID tag will remain deactivated and the process loops over step 659.

In step 661, RFID “X” is activated and receives zone indicator “A” data. In response to reception of this data, the RFID tag “X” sends a further transmission that includes ZIU “A” data (or an indication thereof) along with RFID “X” data (e.g., an ID of the RFID tag “X”).

In step 665, RFID tag “X” waits for a responsive acknowledgement from receiver “R.” If no such acknowledgement is received (e.g., within a certain period of time), then the process returns to step 661 where the transmission is resent. If an acknowledgement is received, then the process returns to step 659 and the RFID tag “X” is deactivated (until being reactivated).

In step 667, receiver “R” waits for incoming transmissions. In step 669, the receiver R receives the transmission that includes data “A” and data “X.” In step 671, receiver “R” communicates the received data “A”, “X” along with data related to “R” (e.g., an ID of “R”) to backend processing system 667 (e.g., a server computer system).

In step 673, an acknowledgement transmission is sent to the RFID tag “X” (e.g., confirming that the earlier transmission was received).

Backend processor 677 is a computer system coupled to a data and/or program store 675 (e.g., a non-transitory storage medium system that includes memory devices, hard disks, and/or other storage elements). Data transmitted from receiver “R” (or ZIU “A”, or RFID Tag “X”) is stored in data store 675. Computer programs (e.g., an RTLS program or an intruder alert program) that runs on the backend processor 677 may also be stored.

Backend processor 677 is coupled to external systems via telephone, and data (e.g., to the Internet or an intranet) connections. Input (e.g., keyboard, mouse, touch screen, etc. . . . ) and output (e.g., a display, speakers, etc. . . . ) devices 679 are also provided to allow operators to view and respond to circumstances in an area being monitored.

Backend processor 677 may also be coupled to various physical access points (e.g., doors, elevators, windows, etc. . . . ) 681 of a facility in order to automatically and/or programmatically control such elements. For example, a computer program being executed by backend processor 677 may monitor a patient and automatically send a signal to unlock or lock a window when a patient is in a particular room.

FIGS. 7A-7C shows examples processes that are executed or implemented in components of an example location tracking system.

FIG. 7A is a flow chart of an example process performed by an RFID tag. In step 700 the RFID tag is in a “deactivated” state. For example, the RFID tag may be part of a wristband worn by a patient in a hospital. Alternatively, the RFID tag may be affixed to a piece of equipment. The tag may be a passive or active RFID and include an identifier that is preferably unique (but not required to be so).

When the tag is in the deactivated state it can be powered down (e.g., in the case of passive RFID) or may be listening on a given radio frequency channel for a particular data set. In certain examples, a passive RFID tag can be excited by a zone indicator RF field and then listen on a particular RF channel for incoming data transmissions. Transmissions between an RFID tag, a zone indicator unit, and/or a remote receiver can be accomplished by RX or LF RF 125 kHz, RX via IR spectrum, RX via audio spectrum, and/or Tx via 433 MHz, 915 MHz, 2.4 GHz, IR, audio, or other types of communication techniques.

In any event, the RFID tag loops between steps 700 and 702 until the location ID of a zone indicator is intercepted in step 702. In the case of passive RFID systems, the interception of the location ID may be part of a transfer of energy from the ZIU to the passive RFID tag to power (or bootstrap) further transmissions or receptions by the RFID tag.

After intercepting the location ID of a ZIU in step 702, the process moves to step 704. The RFID tag constructs an electronic data message that includes an identifier for the tag device, the received location ID, and other, optional, positional information (e.g., directional information as discussed herein). The constructed electronic data message is transmitted to a receiver configured to receive such transmissions.

FIG. 7B is a flow chart of an example process performed by a ZIU. The process shown in FIG. 7B may be complementary to the process performed in FIG. 7A and performed on the RFID tag. As discussed herein, a zone indicator may include a presence detection sensor to detect the presence of a nearby object. Between steps 710 and 712, the presence sensor on the zone indicator runs a loop to detect the presence of a nearby object.

If the presence of an object is detected in step 712, then the process proceeds to step 714. In step 714, the zone indicator is activated and the ID of the ZIU is broadcast. The broadcast may be a broadcast to excite a nearby passive RFID or may be a broadcast to an active RFID tag. In certain examples, upon acknowledgement by an RFID tag (or after a certain period of time) the zone indicator may then send the specified information—e.g., in the form of an electronic data message.

In step 716, after a certain amount of time (e.g., 1 ms or 10 ms, 50 ms, 5 seconds, etc.), the transmitter and/or receiver of the ZIU is turned “off.” In certain examples, switching a zone indicator to an off state causes the zone indicator to stop all RF transmissions. In other examples, RF transmissions are decreased in strength. RF transmissions with such decreased strength are generally insufficient to cause a passive RFID tag to activate.

FIG. 7C is a flow chart of an example data processing operation performed in connection with a detected RFID tag. The process shown in FIG. 7C may be performed on a centralized computing resource (e.g., a computer server system) that communicates with plural zone indicators, receivers, controllers, and/or RFID tags. In other examples, the process is performed on various distributed computing resources. As mentioned with respect to FIG. 6B, step 678 may lead to this example process on the computer server.

In step 730, a server computing system is configured to receive notifications (e.g., electronic messages) from various external computing devices. Included in the received messages are presence indication messages from zone indicators and/or the sensors associated with the zone indicators. For each received presence indication message, the computer process moves to step 732 where the contents of the presence indication message are examined and acted upon.

For example, a presence indication message may include the following information: zone indicator ID, a sub-zone ID, trajectory information, a time stamp (the time stamp may be included in the message or appended by a downstream computing resource—e.g., the server computing system), etc. The information included in the presence indication message may be extracted and stored to a database or the like.

After (or in conjunction with) parsing the presence indication message, the computer system determines if a tag ID has been received that “matches” the received presence indication message.

As explained in connection with FIG. 6B and FIG. 7B, an RFID tag may transmit its own ID along with the ID of a zone indicator which activated the RFID tag. In step 734, the zone indicator ID from the presence indication message is matched against any tag messages that have the same zone indicator ID. As part of this matching process, the time stamps on the respective messages may be compared to determine if they are within some predetermined threshold, for example, 1 or 10 seconds of each other. In other examples, no time stamps are used. Instead, a timer may be started from when the presence indication is received. After expiration of the timer the process may proceed to step 734 to check if any tag ID's have been received that match the presence indication.

If a match is found (e.g., a tag ID is obtained for a corresponding presence indication message), then in step 736 a new record is created for that tag ID. The record may include the tag ID, the zone indicator ID, a time stamp, and other information (e.g., trajectory information may be included in the created record). Multiple records may be analyzed to track the movement of a particular tag ID through a facility. This information can be provided in the form of a real-time display (e.g., that is viewable by security personnel) and/or continually monitored for abnormal behavior.

If, however, a tag ID is not received for a given presence indication message, then in step 738 a security alert is created. In certain examples, a record of the incident is created and stored in a database or the like. In other examples, a notification is automatically sent to a user via a phone call, e-mail, text message, or the like. In certain examples, a display device may include a map of a facility and the security alert may be automatically output to the map to show the location of the zone indicator with the presence detection.

In certain examples, the techniques described herein may be employed on a mobile device (e.g., a smart phone or the like). For example, a mobile device carried by a user may monitor a particular frequency (e.g., 2.4 GHz). Zone indicators may be programmed to transmit zonelDs (and other information as needed) on the monitored frequency when the presence of an object (e.g., the user carrying the mobile device) is detected. The mobile device may receive this transmission and then use a GSM, Wi-Fi, or other wireless communication technique to communicate with a central system.

In certain examples, ZIUs may be setup to handle multiple different types of “tags” (e.g., passive RFID, active RFID, mobile devices, etc. . . . ). For example, upon presence detection the ZIU may first send out an exciting transmission (e.g., to activate a potential passive RFID device) and then successively transmit the zone indicator information over particular communication channel. As the passive RFID, the activate RFID, and the mobile device may all be configured to monitor the same communication channel they may each receive the transmission and then separately communicate that information to a computing remote system. Alternatively, the zone indicator may communicate via different communication channels for the different devices.

In certain examples, the communication range between a zone indicator and a corresponding RFID tag (or other type of mobile device) is relatively short—e.g., no more than a couple of a meters. The communication range between the RFID tag and a receiver (e.g., that is configured to receive the tag ID and zone ID) may be tens of meters—e.g., as is provided by 802.11x protocols. Alternatively, or in addition, the communication range may be quite large when cellular connections are used to transmit device and zone IDs to a remote receiver.

FIGS. 8A and 8B show an example zone indicator unit used as a door management unit and/or a multi-location unit. Device 800 includes a plurality of UHF antennas 834 coupled to a corresponding UHF transceiver module 832. Multiple LF antennas 824 are included for communicating with and/or exciting RFID tags. The LF antennas are coupled to a LF transceiver 824. Also included are eight general use relay outputs 810, eight analog outputs 812, and eight 24 v outputs 816. For example, a presence sensor may be coupled to device 800 via one of the analog outputs 812. A Wi-Fi module and corresponding transceiver 818 is also included. Wi-Fi module 818 may support, for example, 802.11n or 802.11ac wireless communication.

Device 800 includes a micro-controller 804, an internal battery 802, and an interfacing circuit for communicating with external systems (e.g., an electronic door lock) via system-on-module 822 (SOM). These types of controllers may include processing logic that determines when, for example, a door or the like is to be opened. Such processing may be performed locally via the SOM and may include communicating with a central system (e.g., a database). Device 800 may also include onboard logic components 820 for performing local logic operations.

Device 800 includes a Lexan connector 806, an extension port 808, external power interface (and corresponding circuit) 822, an Ethernet port and correspond controller 826, an RS-485 port and controller 828, and a pair of USB ports/controller(s) 830a and 830b.

In certain examples, a multi-location unit that is similar to the device of FIGS. 8A and 8B is provided, but does not include the SOM chip, Wi-Fi module, or Ethernet port. This unit may operate to pass data between a central system and distributed endpoints (e.g., RFID tags, antennas, or other electronic devices) rather than performing more complex local processing (e.g., controlling access to an electronic door lock).

FIG. 9 is a block diagram of an exemplary computing system according to certain example embodiments. A processing system 900 includes a central processing unit or CPU 902, a system bus 904 that communicates with RAM 906, and storage 908. The storage 908 can be magnetic, flash based, solid state, or other storage technology. The system bus 904 may also communicate with a user input adapter 910 (e.g., PS/2, USB interface, or the like) that allows users to input commands to the processing system via a user input device 912 (e.g., a keyboard, mouse, touch panel, or the like). The results of the processing may be displayed to a user on a display 916 via a display interface 914 (e.g., a video card or the like).

The processing system 900 may also include a network interface 918 that may facilitate wired (e.g., Ethernet) or wireless communication (Wi-Fi/802.11x protocols, cellular technology, and the like) with external systems 922 or databases 920.

External systems 922 may include other processing systems, systems that provide third party services, etc. As described herein, external systems 922 may include distributed controller units or other computing resources. External systems 922 may include other types of computing systems such as, for example, network attached storage (NAS) that holds large amounts of data (e.g., thousands or millions of electronic documents/records). Such external systems for storage, along with the internal storage and memory, may form a storage system for storing and maintaining information on the test results of one or more patients (e.g., thousands of patients) or the movement patterns of each one of plural RFID tags.

The database 920 may include relational, object orientated, or other types of databases for storing information (e.g., such as location information on tracked assets, history information, etc.).

In other words, the processes, techniques, and the like, described herein are, at least in part, implemented by a computing system (e.g., a server, central computing resource, etc.). Such implementations include configurations (executable computer program code structures—e.g., sometimes referred to as software) of processing systems to carry out certain aspects of example embodiments.

FIG. 10 shows another example ZIU. ZIU 1000 includes a housing 1001 that holds a micro controller unit (MCU) 1002 (e.g., a processing circuit or processor) that runs firmware to control operations on the ZIU 1000. The firmware may include computer code that is used to perform calculations on data that is received via transceivers and/or connected sensors. This allows for a distributed system and facilitates the expansion of a particular system over larger and larger areas and the monitoring of more and more tags. The housing may completely enclose the components therein or may only partially enclose the component while leaving others open to the outside.

MCU 1002 is electrically coupled to a 916 MHz transceiver 1004 that is in-turn connected to an external antenna 1006. Transceiver 1004 may be used to wirelessly communicate with a central management unit (CMU)—e.g., a centralized computer system that may include a database. Messages sent via the transceiver 1004 may include system messages (e.g., the status of the ZIU for monitoring purposes) and user RFID tag messages. In certain examples, a user RFID message may include an alert that is specifically triggered by the user activating a button on their respective RFID tag. In certain examples, transceiver 1004 may be used as a gateway to other ZIUs. This may result in a mesh like communication topology. In certain examples, transceiver 1004 is always on. In other examples, transceiver 1004 defaults to “off” and is only turned on for a certain period of time in response to a presence detection. In certain examples, transceiver 1004 may be replaced by a wired connection to the CMU.

Transceiver 1008 is connected to antennas 1010A, 1010B, and 1010C. These antennas may be used to communicate (both reception and transmission) with tags that are proximate to ZIU 1000. Details of such communications are discussed in relation to, for example, FIGS. 6A and 6B.

LED Lexan 1012 is provided for a viewable status indicator of the ZIU 1000. 125 kHz transmitter 1014 along with external 1018 and/or internal 1020 antennas are used to generate an LF field to excite local tag devices (e.g., RFID tags).

Internal battery 1016 provides power for the various components of the ZIU. Power supply circuit 1024 and supply connector 1022 can be used to tap into an external power source. In certain examples, a solar array may be coupled and provide the ability to recharge the internal battery. This type of solution can provide for flexible deployment options in outdoor areas are wires may not be needed. In certain examples, the ZIU 1000 may be connected to a standard power grid (e.g., part of a health care facilities internal power grid). Battery 1016 may provide backup power in case of power interruption.

Sensor 1026 is a presence sensor used for detecting the presence of a nearby object. The sensor can be any of the sensors described herein. As discussed herein, multiple sensors may be included for a given ZIU. In certain examples, the may provide a simple digital signal output of “1” or “0” (e.g., with “1” for object detected) or might be of an interactive type that will send proximity data. For example, an output from the sensor may indicate that 200, 199, 198 . . . 150 cm—to indicate an object has been detected and is moving into the area covered by this ZIU.

Digital input 1029 and general use relay 1030 along with their corresponding external connectors 1034 and 1036 can be used to connect to external devices. This can include other sensors, a controller unit, other ZIUs, etc.

Memory 1032 is a memory device for storing data and may be, for example, flash memory. It will be appreciated that any type memory for storing data may be used. ZIU 1000 may store a corresponding ZIU identifier (e.g., the identifier that is transmitted to in-range tags). The memory device may also store a current list of “active” or recently activated tags, log information (e.g., a time stamped list of all tags that have been activated), a list of corresponding presence sensors coupled to the ZIU, etc. The current list of activated tags may be used to filter out stationary tags or tags that have recently communicated with the ZIU.

One aspect of the embodiments described herein is the decreased consumption of power for LF transmissions as traditional uses of zone locator based RTLS solution requires near constant (e.g., 24/7) operation of all LFs transmitters. Moreover, the LF transmissions of the zone devices may have needed to run on frequent duty and power cycles—so that the RFID devices will not “miss” the LF transmission. The power usage in such an environment may have resulted in the zone locators being wired for power. The power lines in a typical installation may be 24V and use a central regulated power supply with long cable runs. The installation for such a system (e.g., just the power requirements) can be labor intensive.

The embodiments described herein may not suffer from such power requirements since the component in the ZIU that is running “full time” is a sensor that typically consumes very low power. Such power requirements thus can enable certain example ZIUs to be battery operated (e.g., with a battery replacement about once every 18 months—or longer if connected to a solar power source).

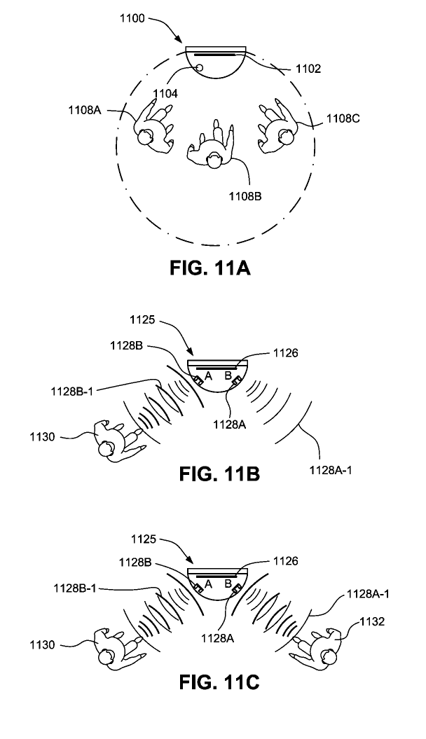

FIGS. 11A-11C show diagrams of example deployed zone indicator units according to certain example embodiments.

FIG. 11A shows a ZIU 1100 with a passive infrared (PIR) sensor 1104 and an LF transmitter 1102. Within range of the PIR sensor 1104 are three people 1108A, 1108B, and 1108C. Upon detection of one of these people, all tags within the coverage area of the LF transmitter 1102 (e.g., the RFID tags carried each of the persons) are activated and will report their location to a receiver.

FIGS. 11B and 110 show an example ZIU 1125 with a LF transmitter 1126 and two ultra-sonic range finder sensors 1128A and 1128B. Sensors 1128A and 1128B are arranged at roughly a 90 degree angle and cover different sub-zones associated with ZIU 1125 (e.g., there is no overlap in coverage area). The coverage areas are represented by 1128A-1 and 1128B-1. In the case of sensor 1128B, the sensor detects the presence of person 1130 via a return signal. Upon detection of person 1130, the LF transmitter 112 activates and sends a transmission that includes the ID of the ZIU, the ID of the sub-zone, and any trajectory information that has been calculated.

In certain instance, ZIU 1125 can be deployed in corridors where direction information (in addition to a fixed location) may be advantageous. In FIG. 11B, ZIU 1125 may thus determine (or infer) that the RFID tag (and thus the person) is heading in a particular direction.

FIG. 11C is similar to FIG. 11B except in this scenario two different people are being detected—one by each sensor. In this type of scenario, if there is a sufficient difference in arrival time within the covered zone (e.g., greater than 100 ms), then ZIU (and the RTLS system in general) may be able to determine which tag is under zone A and which in zone B. However, if the two tags arrive at exactly the same time (e.g., within 10 ms of each other), then the exact sub-zone within ZIU 1125 may not be able to be determined for the respective tags. Instead, the tags may be generally reported to be under just the ZIU ID (or under a combination of sub-zone A and B).

Certain examples herein are described in terms of sequences of actions that can be performed by, for example, elements of a programmable or programmed computer system. It will be recognized that various actions also could be performed by specialized circuits (e.g., discrete logic gates interconnected to perform a specialized function or application-specific integrated circuits—ASIC), by program instructions executed by one or more processors, or by a combination of both.

Moreover, portions of the example embodiments can also be considered as embodied entirely within any form of non-transitory computer-readable storage medium (e.g., RAM, ROM, so-called hard drives, portable media—DVDs, etc.) having stored therein an appropriate set of computer readable or executable instructions for use by or in connection with an instruction-execution system, apparatus, or device, such as a computer-based system, processor-containing system, or other system that can fetch instructions from a medium and execute the instructions.

Thus, the invention may be embodied in many different forms, not all of which are described above. It will be appreciated that the techniques described herein may be applied to a variety of different contexts. For example, while some examples herein may be in a hospital or formal medical setting, the techniques and embodiments herein also may be applied in a home environment, an office environment, in a prison, or other facility or structure for which location tracking of assets or people may be advantageous.

The techniques described herein may be applied in other contexts as well. For example, a cross walk at an intersection may employ presence detection to selectively communicate with RFID devices carried by blind pedestrians. When the presence of a pedestrian is detected, a locally placed communication module is activated to send a transmission into the local area. The transmission may be used to excite a passive RFID tag or communicate with an active RFID tag. In either case, the purpose of the transmission is to see if there are any RFID tags carried by blind pedestrians that may be nearby. If a responsive transmission from such a tag is received the functionality of the cross walk may be adjusted. For example, the time the walk sign is active may be increased or an audible indication may be triggered (or the sound level increased).

By making use of presence detection, the communication module may be set to a default state so that it is not constantly broadcasting. Similarly, functionality of the cross walk may be adjusted to better accommodate the blind pedestrian (e.g., only when a valid RFID tag within range). In other words, the techniques described herein may be applied in many different circumstances and situations.

Any type of communication (e.g., audio, radio, light, etc.) may be used by the zone indicators and their corresponding transmitter to advertise or broadcast the location or zone identifier.

While the technology herein has been described in connection with what is presently considered to be preferred embodiments, it is to be understood that the invention is not limited to the disclosed embodiment, but on the contrary, is intended to cover modifications and equivalent arrangements as now will be apparent to those skilled in the art and as included within the spirit and scope of the claims.

What is claimed is:

1. A tracking system comprising:
at least one electronic device that includes a wireless transceiver and a memory configured to store a corresponding device identifier for the least one electronic device;
a plurality spatially distributed presence sensors, each presence sensor being configured to detect local presence of an object; and
a plurality of spatially distributed normally “off” wireless transmitters that are each electronically coupled to at least one of the plurality of presence sensors, the plurality of wireless transmitters being configured to turn “on” in response to detection of the local presence of an object by a respectively corresponding presence sensor and to wirelessly transmit a location identifier associated with that respective wireless transmitter.

2. The tracking system of claim 1, wherein the wireless transceiver of the at least one electronic device is configured to:
receive the location identifier communicated from the respective wireless transmitter; and
transmit, via the wireless transceiver of the at least one electronic device, the received location identifier and the corresponding device identifier to a remote wireless receiver.

3. The tracking system of claim 1, wherein:
each one of the plurality of presence sensors is associated with a sensor identifier,
the wireless transmission includes the sensor identifier of the presence sensor that detected the presence of the object.

4. The tracking system of claim 1, wherein:
the wireless transmission includes trajectory and/or movement information regarding the sensed object.

5. The tracking system of claim 1, wherein:
the at least one electronic device is at least one passive RFID tag,
the plurality of wireless transmitters each include an RFID tag exciter configured to generate an RF exciter signal to an in-range passive RFID tag to thereby power the in-range passive RFID tag, and
the RF exciter signal is generated in response to detection of the local presence of an object, where the RF exciter signal is the wireless transmission that includes the location identifier.

6. The tracking system of claim 1, further comprising:
a plurality of spatially distributed zone indicator units (ZIU) that each include:
at least one of the plurality of transmitters;
at least one of the presence sensors; and
at least one computer processor coupled to the at least one of the plurality of transmitters and the least one of the presence sensors.

7. The tracking system of claim 6, wherein each one of the plurality of spatially distributed ZIUs include a battery configured to provide power to the at least one of the plurality of transmitters, at least one of the presence sensors, and the at least one computer processor,
wherein each of the plurality of ZIUs is self-contained and configured to operate without reliance on a centralized power source.

8. The tracking system of claim 1, further comprising:
a plurality electronic controllers that are each coupled to (1) at least one corresponding presence sensor from the plurality of presence sensors and (2) at least one corresponding wireless transmitter from the plurality of wireless transmitters, each of the plurality of electronic controllers including a processor circuit configured to:
accept indications of presence and/or movement from the at least one corresponding presence sensor;
control the generation of RF signals by the at least one corresponding wireless transmitter based on the accepted indications;
determine, based on indications of movement from the at least one corresponding presence sensor, trajectory information for an object; and
instruct the at least one corresponding wireless transmitter to transmit an RF signal that includes the determined trajectory information.

9. The tracking system of claim 1, further comprising:
a plurality of remote receivers;
a computer system coupled to the plurality of remote receivers, the computer system including at least one programmed processor circuit which:
accepts an electronic message that includes (1) an indication of a detected local presence of an object and (2) a corresponding location identifier that is associated with the wireless transmitter coupled to the presence sensor that detected the local presence of the object;
determine if an associated device identifier has not also been received, and, if not, generate a notification alert; and
if the associated device identifier has been received, generate and store, to a non-transitory storage medium system, a record that includes the location identifier and the device identifier.

10. A movement tracking system comprising:
at least one RFID tag exciter configured to be in a normally OFF state;
at least one object presence sensor configured to detect presence and/or movement of an object within range of the at least one object presence sensor; and
an electrical circuit coupled to the at least one RFID tag exciter and to the at least one object presence sensor, the electrical circuit being configured to cause activation of the at least one RFID tag exciter from the normally OFF state to a temporary ON state in response to a detected object by the least one object presence sensor,
wherein, when the RFID tag exciter is in the ON state, an RF signal is emitted by the at least one RFID tag exciter to excite an RFID tag that is within excitation range.

11. The movement tracking system of claim 10, wherein the RFID tag exciter, after being in the ON state for a predetermined period of time, is automatically switched to the OFF state.

12. The movement tracking system of claim 10, wherein the RFID tag exciter is actively switched to the OFF state after an acknowledgement transmission is received from the RFID tag.

13. The movement tracking system of claim 10, wherein a plurality of presence sensors are coupled to the at least one RFID tag exciter, with each one of the presence sensors being configured to detect an object in respective spatial volumes.

14. A zone indicator unit (ZIU) comprising:
computer readable storage configured to store at least a ZIU identifier for the ZIU;
at least one object sensor configured to detect presence and/or movement of an object;
a wireless transmitter configured to transmit an RF signal to a mobile electronic device that includes a transceiver; and
a processing system that includes at least one processor circuit coupled to the computer readable storage, the at least one object sensor, and the wireless transmitter, the processing system being configured to:
receive a signal from the at least one object sensor that object movement and/or presence has been detected; and
in response to reception of the signal, cause the wireless transmitter to transmit an RF signal that carries the ZIU identifier.

15. The ZIU of claim 14, wherein the at least one object sensor includes at least one of (a) a passive infrared sensor, (b) a ultra-sonic range finder sensor, or (c) a laser sensor.

16. The ZIU of claim 14, wherein the processing system is further configured to:
cause an electronic presence detection message to be sent to a remote computer system, the electronic presence detection message including the ZIU identifier even if there is no communication with a mobile device.

17. The ZIU of claim 14, wherein the processing system is further configured to:
calculate object trajectory information based on the detected object presence and/or movement,
wherein the transmitted RF signal carrying the ZIU identifier also includes the calculated object trajectory information.

18. The ZIU of claim 14, wherein a plurality of sensors are respectively configured to cover different spatial volumes with respect to the ZIU,
wherein each one of the plurality of sensors is associated with a different sensor identifier,
wherein the transmitted RF signal carrying the ZIU identifier also includes the sensor identifier of the sensor that detected the object movement and/or presence.

19. The ZIU of claim 14, wherein the wireless transmitter is a low frequency wireless transmitter.

20. The ZIU of claim 14, further comprising:
at least one processor; and
at least one transceiver coupled to the at least one processor and that communicates over a radio frequency that is different than the wireless transmitter uses to communicate the ZIU identifier,
the at least one transceiver configured to:
receive wireless data transmissions, on the different radio frequency and from mobile electronic devices, that include a location identifier and an identifier for the corresponding mobile electronic device,
the at least one processor configured to:
identify those data transmissions that include a location identifier that is different from the ZIU identifier that is stored with the respective ZIU; and
validate the identifier for the corresponding mobile electronic device.

21. A method of operating a plurality of spatially distributed zone indicators to track a plurality of mobile devices that each include a wireless transceiver, each zone indicator including (1) a presence sensor configured to detect object presence and/or movement, (2) a wireless transmitter configured to communicate with in-range mobile devices, and a memory configured to store a zone indicator identifier, the method comprising:
maintaining the plurality of wireless transmitters in a normally OFF state such that the zone indicator identifier for the respective zone indicator is not being transmitted;
detecting, via a presence sensor, movement or presence of an object;
responsive to detection of the movement or presence of the object, switching the wireless transmitter of a corresponding zone indicator to a temporary ON state to thereby cause transmission of a wireless message that includes the zone indicator identifier stored in the memory of the corresponding zone indicator.

22. The method of claim 21, further comprising:
determining, via a processor circuit, a speed and/or trajectory associated with detection of the object,
wherein the wireless message includes the determined speed and/or trajectory.

23. The method of claim 21, further comprising:
receiving the wireless message at the at least one of the plurality of mobile devices; and
transmitting another wireless message, via the at least one mobile device and to a remotely located wireless receiver, that includes at least the zone indicator identifier and a mobile device identifier for that mobile device.
